(19) United States
(12) Patent Application Publication
(10) Pub. No.: US 2025/0238221 A1
(43) Pub. Date: Jul. 24, 2025

(54) SYSTEM OF DOMESTIC APPLIANCES AND METHODS FOR ALERTING UPDATES FOR ONE OR MORE NETWORK CONNECTED APPLIANCES

(71) Applicant: Haier US Appliance Solutions, Inc., Wilmington, DE (US)

(72) Inventors: Haitian Hu, Louisville, KY (US); Hairong Li, Louisville, KY (US)

(21) Appl. No.: 18/421,657

(22) Filed: Jan. 24, 2024

(51) Int. Cl. G06F 8/65

(52) U.S. Cl. CPC G06F 8/65

(57) ABSTRACT

A method of operating a system of domestic appliances including at least one network connected appliance includes determining that a software update is available for the at least one network connected appliance; determining a prioritized list of notification delivery manners for alerting the software update; and initiating a responsive action in response to determining the prioritized list of notification delivery manners, wherein initiating the responsive action includes emitting a notification via a most optimal delivery manner of the prioritized list of notification delivery manners.

### FIELD OF THE INVENTION

The present subject matter relates generally to domestic appliances, and more particularly to methods for prioritizing notification manners for updates to appliances.

### BACKGROUND OF THE INVENTION

Domestic appliances are increasingly becoming smarter and more connected with the advancement of the internet age. Many households include a plurality of network connected appliances, such as smart refrigerators, smart laundry machines, smart speakers, and the like. Such appliances include sophisticated software that can be upgraded over time with improvements in functionality. Since many smart appliances are connected to the internet, such upgrades can be delivered over the air (OTA) to the appliances and installed with minimal input or exertion from users.

However, existing methods for indicating the availability of software upgrades provide several drawbacks. For instance, many notifications are delivered at inopportune times such that users are not sufficiently notified of the availability. Moreover, multiple delivery modes, methods, or manners may be incorporated, resulting in an inundation of notifications, which may be undesirable.

Accordingly, a method of prioritizing and efficiently emitting or delivering notifications of upgrades would be beneficial. In particular, a system of analyzing usage and incorporating optimal notification manners would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a method of operating a system of domestic appliances is provided. The system may include at least one network connected appliances. The method may include determining that a software update is available for the at least one network connected appliance; determining a prioritized list of notification delivery manners for alerting the software update; and initiating a responsive action in response to determining the prioritized list of notification delivery manners, wherein initiating the responsive action includes emitting a notification via a most optimal delivery manner of the prioritized list of notification delivery manners.

In another exemplary aspect of the present disclosure, a computing system for emitting software update notifications is provided. The computing system may include at least one network connected appliance; one or more processors in communication with the at least one network connected appliance; and one or more non-transitory computer-readable media that collectively store instructions that, when executed by the one or more processors, cause the computing system to perform operations. The operations may include determining that a software update is available for the at least one network connected appliance; determining a prioritized list of notification delivery manners for alerting the software update; and initiating a responsive action in response to determining the prioritized list of notification delivery manners, wherein initiating the responsive action includes emitting a notification via a most optimal delivery manner of the prioritized list of notification delivery manners.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 illustrates a connected network of appliances according to exemplary embodiments of the present disclosure.

FIG. 2 illustrates a workflow diagram of an example process for retrieving consumer data according to exemplary embodiments of the present disclosure.

FIG. 3 illustrates a workflow diagram of generating synthetic data according to exemplary embodiments of the present disclosure.

FIG. 4 illustrates a block diagram of an example hardware diagram for a platform run on a computing device according to exemplary embodiments of the present disclosure.

FIG. 5 illustrates a flowchart diagram of an example method for prioritizing notification delivery manners according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

According to the present disclosure, systems and methods for analyzing and predicting user behavior are discussed. In detail, using embeddings, a computer system may intelligently determine or predict certain operations, desired outputs, potential failures, and/or behavioral anomalies with increasing accuracy. According to one example, the system may create embeddings from user data associated with particular repeat options, such as acknowledging cloud notifications, selected on a home appliance, e.g., a microwave oven. The embeddings may be categorized into a cluster of users that utilize the same options. In some implementations, synthetic data may be generated and used to bolster the clusters and place new users into appropriate clusters according to limited usage. When the new user is placed into an assigned cluster, certain predictions may be made by the system, for instance, relating to the operations that will be selected by the new user. Thus, predictions (e.g., on early faults, desired recipes or food choices, etc.) may be made. These predictions may be forwarded to the user or to a technician in preparation for maintenance. Additionally or alternatively, these predictions may be sent to the manufacturer and used to improve functionality of appliances for future iterations.

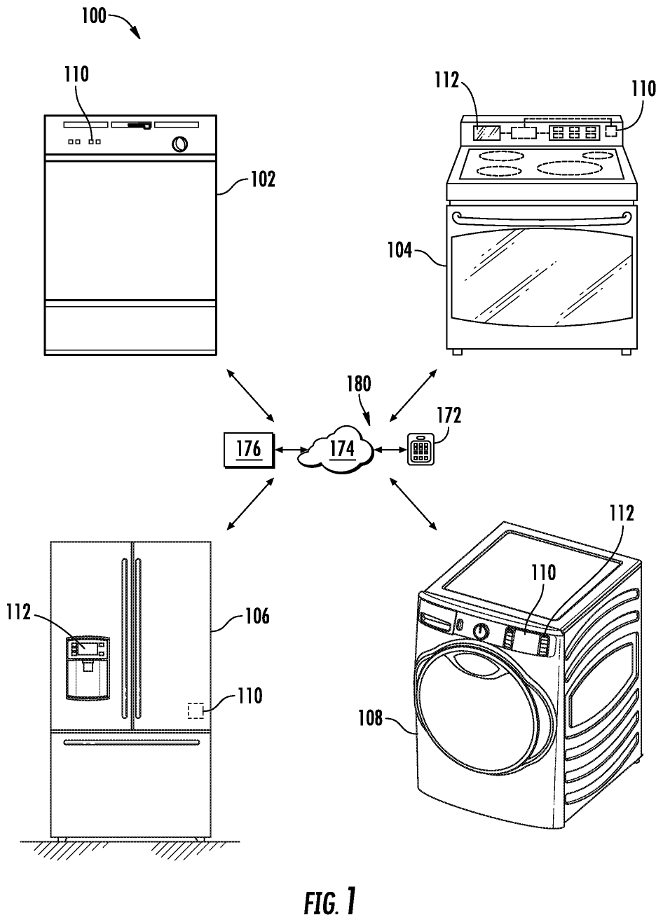

Referring to FIG. 1, a schematic diagram of an external communication system 180 will be described according to an exemplary embodiment of the present subject matter. In general, external communication system 180 is configured for permitting interaction, data transfer, and other communications between one or more appliances 100 and one or more external devices. For example, this communication may be used to provide and receive operating parameters, user instructions or notifications, performance characteristics, user preferences, or any other suitable information for improved performance of the one or more appliances 100. In addition, it should be appreciated that external communication system 180 may be used to transfer data or other information to improve performance of one or more external devices or appliances and/or improve user interaction with such devices.

For example, external communication system 180 permits a controller 110 of at least one appliance 100 to communicate with a separate device external to the at least one appliance 100, referred to generally herein as an external device 172. As described in more detail below, these communications may be facilitated using a wired or wireless connection, such as via a network 174. In general, external device 172 may be any suitable device separate from the one or more appliances 100 that is configured to provide and/or receive communications, information, data, or commands from a user. In this regard, external device 172 may be, for example, a personal phone, a smartphone, a tablet, a laptop or personal computer, a wearable device, a smart home system, or another mobile or remote device.

In addition, a remote server 176 may be in communication with the one or more appliances 100 and/or external device 172 through network 174. In this regard, for example, remote server 176 may be a cloud-based server 176, and is thus located at a distant location, such as in a separate state, country, etc. According to an exemplary embodiment, external device 172 may communicate with a remote server 176 over network 174, such as the Internet, to transmit/receive data or information, provide user inputs, receive user notifications or instructions, interact with or control the one or more appliances 100, etc. In addition, external device 172 and remote server 176 may communicate with the one or more appliances 100 to communicate similar information.

In general, communication between the one or more appliances 100, external device 172, remote server 176, and/or other user devices or appliances may be carried using any type of wired or wireless connection and using any suitable type of communication network, non-limiting examples of which are provided below. For example, external device 172 may be in direct or indirect communication with the one or more appliances 100 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 180 is described herein according to an exemplary embodiment of the present subject matter. However, it should be appreciated that the exemplary functions and configurations of external communication system 180 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Referring still to FIG. 1, a system of connected devices 100 according to exemplary embodiments of the present subject matter is illustrated. As shown, system of connected devices (e.g., appliances) 100 may generally include a first appliance 102 (e.g., illustrated herein as a dishwashing appliance), a second appliance 104 (e.g., illustrated herein as an oven appliance), a third appliance 106 (e.g., illustrated herein as a refrigerator appliance), and a fourth appliance 108 (e.g., illustrated herein as a laundry appliance). Interaction between each of the first appliance 102 and the second appliance 104 will be described below according to exemplary embodiments of the present subject matter. However, it should be understood that the descriptions may apply to any and/or all of connected devices 100 shown. Further, it should be appreciated that the specific appliance types and configurations are only exemplary and are provided to facilitate discussion regarding the use and operation of an exemplary system of connected devices 100. The scope of the present subject matter is not limited to the number, type, and configurations of appliances set forth herein. Moreover, detailed descriptions of each particular appliance will be omitted for brevity.

For example, the system of connected appliances 100 may include any suitable number and type of “appliances,” such as “household appliances” or “domestic appliances.” These terms are used herein to describe appliances typically used or intended for common domestic tasks, e.g., such as laundry appliances as illustrated in the figures. According to still other embodiments, these “appliances” may include but are not limited to a refrigerator, a dishwasher, a microwave oven, a cooktop, an oven, a washing machine, a dryer, a water heater, a water filter or purifier, an air conditioner, a space heater, and any other household appliance which performs similar functions in addition to network communication and data processing. Additional or alternative appliances or electronics may be included in system 200, such as smart speakers, tablets, mobile devices, laptop computers, or the like. Moreover, although only four appliances are illustrated, various embodiments of the present subject matter may also include five or more appliances, or three or fewer appliances, each of which may transmit, receive, and/or relay signals among connected appliances and/or other external devices.

As illustrated, each of first appliance 102, second appliance 104, remote user interface device 172, or any other devices or appliances in system of connected appliances 100 may include or be operably coupled to a controller, identified herein generally by reference numeral 110. As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 110 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 110 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 110 may be operable to execute programming instructions or micro-control code associated with an operating cycle of an appliance. In this regard, the instructions may be software or any set of instructions that when executed by the processing device, cause the processing device to perform operations, such as running one or more software applications, displaying a user interface, receiving user input, processing user input, etc. Moreover, it should be noted that controller 110 as disclosed herein is capable of and may be operable to perform any methods, method steps, or portions of methods as disclosed herein. For example, in some embodiments, methods disclosed herein may be embodied in programming instructions stored in the memory and executed by controller 110. The memory devices may also store data that can be retrieved, manipulated, created, or stored by the one or more processors or portions of controller 110. The data can include, for instance, data to facilitate performance of methods described herein. The data can be stored locally (e.g., on controller 110) in one or more databases and/or may be split up so that the data is stored in multiple locations. In addition, or alternatively, the one or more database(s) can be connected to controller 110 through any suitable communication module, communication lines, or network(s).

Additionally or alternatively, one or more of the appliances 102, 104, 106, 108 may include a display or interactive user input 112. For instance, display 112 may include a screen or other visual component capable of displaying information, instructions, data, content, entertainment, or the like. Display 112 may include one or more inputs (e.g., touch inputs, buttons, switches, etc.). Accordingly, users may interact with each of the appliances via the display 112 (e.g., to acknowledge notifications or alerts).

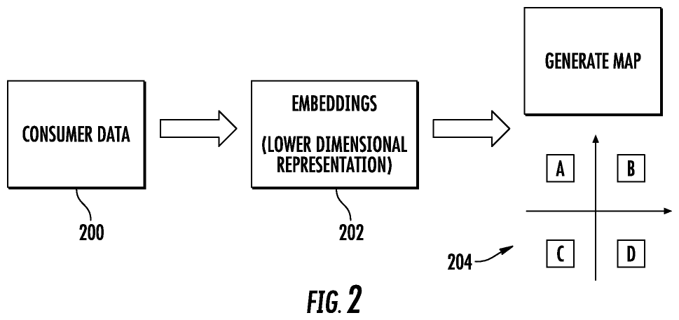

FIG. 2 illustrates a flow chart of collecting input data 200 and generating embeddings 202 for the input data 200 (e.g., consumer data) collected from the system of connected appliances 100. The input data 200 may include different types, forms, or variations of input data. As examples, in various implementations, the input data 200 may include consumer data such as sensor reading (e.g., pressure sensors, temperature sensors, humidity sensors, seismic sensors, etc.), software revision reporting, fault code information, appliance operating mode (e.g., dishwasher operations, washing machine operations, etc.), cycle specific and option selection information, and the like. In additional or alternative implementations, the input data 200 may include product user data such as consumable usage (e.g., dishwasher detergent pods, laundry detergent, filters, etc.), notifications on low levels of consumables, cycles status, and the like. It should be noted that any suitable data from any suitable appliance may be incorporated as input data 200.

In some implementations, one or more neural networks may be used to provide an embedding 202 based on the input data 200. For example, the embedding 202 can be a representation of knowledge abstracted from the input data 202 into one or more learned dimensions. In some instances, embeddings 202 can be a useful source for identifying related entities (e.g., data points from input data 200). In some instances, embeddings 202 can be extracted from the output of the network, while in other instances embeddings 202 can be extracted from any hidden node or layer of the network (e.g., a close to final but not final layer of the network). Embeddings 202 may be useful for generating clusters of users, clusters of failure points, product suggestions, recipe suggestions, entity or object recognition, etc. In some instances, embeddings 202 may be useful inputs for downstream models. For example, embeddings 202 may be useful to generalize input data 200 (e.g., search queries) for a downstream model or processing system. In some implementations, the machine-learned model can be used to preprocess the input data 200 for subsequent input into another model. For example, the machine-learned model can perform dimensionality reduction techniques and embeddings (e.g., matrix factorization, principal components analysis, singular value decomposition, word2vec/GLOVE, and/or related approaches); clustering; and even classification and regression for downstream consumption.

In some implementations, the machine-learned model can perform various types of clustering. For example, the machine-learned model can identify one or more previously-defined clusters to which the input data most likely corresponds. As another example, the machine-learned model can identify one or more clusters within the input data 200. That is, in instances in which the input data 200 includes multiple objects, documents, or other entities, the machine-learned model may sort the multiple entities included in the input data 200 into a number of clusters. In some implementations in which the machine-learned model performs clustering, the machine-learned model can be trained using unsupervised learning techniques. In some implementations, the machine-learned model may perform anomaly detection or outlier detection. For example, the machine-learned model may identify input data 200 that does not conform to an expected pattern or other characteristic (e.g., as previously observed from previous input data). As an example, the anomaly detection may be used for system failure detection.

In some implementations, the machine-learned model may receive and use the input data 200 in its raw form. In some implementations, the raw input data can be preprocessed. Thus, in addition or alternatively to the raw input data, the machine-learned model may receive and use the preprocessed input data.

In some implementations, the machine-learned model may be or include one or more generative networks such as, for example, generative adversarial networks (as will be described in more detail below). Generative networks may be used to generate new data such as new images or other content.

In some implementations, the machine-learned model may be or include an autoencoder. In some instances, the aim of an autoencoder is to learn a representation (e.g., a lower-dimensional encoding) for a set of data, typically for the purpose of dimensionality reduction. For example, in some instances, an autoencoder may seek to encode the input data and then provide output data that reconstructs the input data from the encoding. Recently, the autoencoder concept has become more widely used for learning generative models of data. In some instances, the autoencoder can include additional losses beyond reconstructing the input data.

In some implementations, the machine-learned model may be or include one or more other forms of artificial neural networks such as, for example, deep Boltzmann machines; deep belief networks; stacked autoencoders; etc. Any of the neural networks described herein can be combined (e.g., stacked) to form more complex networks.

In some implementations, the input to the machine-learned model(s) of the present disclosure may be latent encoding data (e.g., a latent space representation of an input, etc.). The machine-learned model(s) may process the latent encoding data to generate an output. As an example, the machine-learned model(s) may process the latent encoding data to generate a recognition output. As another example, the machine-learned model(s) may process the latent encoding data to generate a reconstruction output. As another example, the machine-learned model(s) may process the latent encoding data to generate a search output. As another example, the machine-learned model(s) may process the latent encoding data to generate a reclustering output. As another example, the machine-learned model(s) may process the latent encoding data to generate a prediction output.

In some implementations, the input to the machine-learned model(s) of the present disclosure may be sensor data. The machine-learned model(s) may process the sensor data to generate an output. As an example, the machine-learned model(s) may process the sensor data to generate a recognition output. As another example, the machine-learned model(s) may process the sensor data to generate a prediction output. As another example, the machine-learned model(s) may process the sensor data to generate a classification output. As another example, the machine-learned model(s) may process the sensor data to generate a segmentation output. As another example, the machine-learned model(s) may process the sensor data to generate a segmentation output. As another example, the machine-learned model(s) may process the sensor data to generate a visualization output. As another example, the machine-learned model(s) may process the sensor data to generate a diagnostic output. As another example, the machine-learned model(s) may process the sensor data to generate a detection output.

Referring still to FIG. 2, in response to receipt of the input data, the machine-learned model may provide the output data. The output data may include different types, forms, or variations of output data. As examples, in various implementations, the output data may include one or more maps 204 including clusters of similar embeddings. For example, the machine-learned model may, upon processing the input data 200 as a plurality of data points, sort the processed data (e.g., embeddings) according to clusters as visualized on a 2- or 3-dimensional map. As seen in FIG. 2, the machine-learned model may categorize a user (or a new home appliance) into one of cluster A, cluster B, cluster C, or cluster D. Accordingly, the machine-learned model may make a prediction as to operating characteristics most likely to be displayed or exhibited by the new home appliance. It should be noted that in some implementations, more or fewer cluster regions may be generated, and the disclosure is not limited to the example shown here.

In some implementations, the output data may include predictions. For example, the machine-learned model may process input data 200 related to failures of related home appliances (e.g., failure of a refrigeration coil of a refrigerator appliance). Upon determining that the new home appliance is near a cluster that exhibits a particular failure point, the machine-learned model may predict a failure point of the new home appliance. Accordingly, the new user may be notified as to a potential failure. Additionally or alternatively, one or more repair technicians may be alerted as to the potential for failure, and appropriate diagnostic action may be taken. In some instances, a repair call may be scheduled automatically in prediction of a failure. Additionally or alternatively, repair items may be ordered, or a prompt may be sent to the user to order repair items. It should be noted that the embodiments described herein are not limited to the examples discussed above, and that the machine-learned model may process and sort users and/or new appliances according to any suitable metrics.

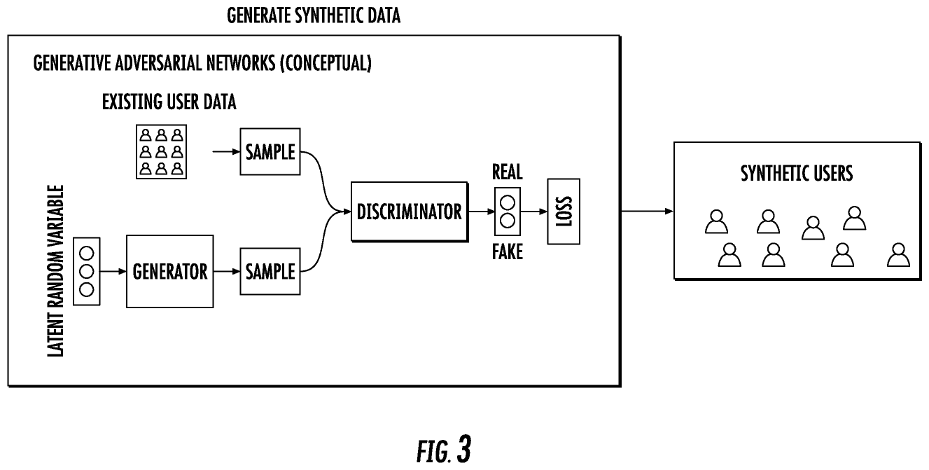

As shown in FIG. 3, the machine-learned model may generate synthetic data to be used to further train the model in analyzing new data. In at least some examples, generative adversarial networks (GAN) may be utilized. GANs may be neural networks that learn to create synthetic data similar to known input data 200. For instance, known data points may be input to a discriminator network to be compared with generated data points. The discriminator network may then determine the difference between the generated data points and the known data points. Through iteration, the discriminator network learns aspects of the known data points. A generator network may then utilize the learned features of the discriminator network to generate synthetic data points. GANs may then generate data points that can supplement real data points in generating clusters and predicting events.

Returning briefly to FIG. 2, the machine-learned model may transmit the latent space, 2- or 3-dimensional map to a mobile device (e.g., mobile device 172). For instance, the mobile device may include a display (e.g., a liquid crystal display, a light emitting diode display, etc.). A user (e.g., a technician) may then view the clusters. According to some implementations, the user may choose to observe clusters according to selected traits or based on selected input data 200. Additionally or alternatively, the machine-learned model may predict recommendations and/or alerts. For instance, the machine-learned model may determine that a new user belongs to a cluster that normally uses certain ingredients in recipes. Thus, the prediction may result in recommendations on recipes or ingredients to purchase or use. Further, the machine-learned model may provide recommended purchase offers on additional appliances according to a cluster placement.

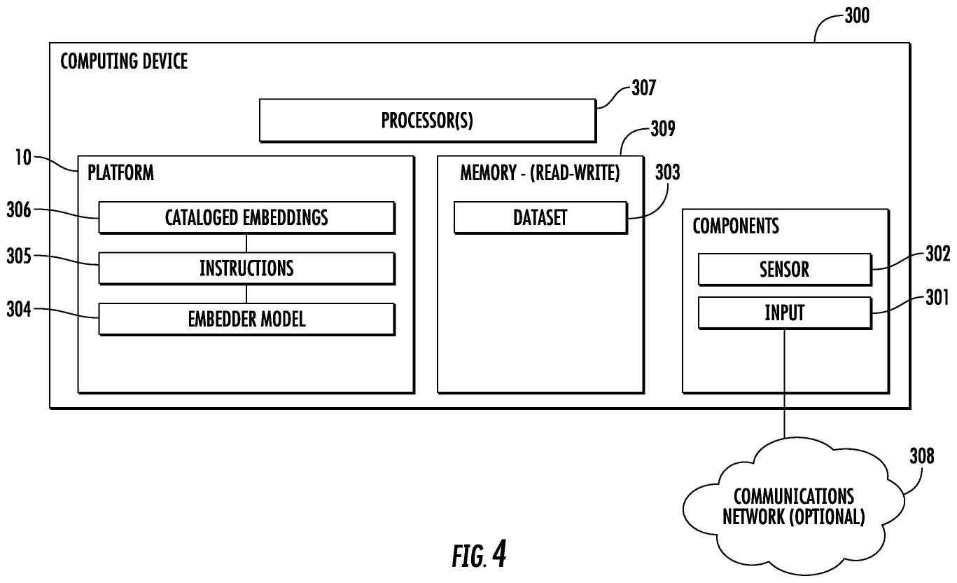

FIG. 4 illustrates an example hardware diagram for a platform 10 run on a computing device 300. In some embodiments, computing device is provided in or on mobile device 172. The computing device 300 may include one or more processors 307 that can execute computer readable instructions 305 for utilizing components that include, for example, a sensor 302 and an input (e.g., button, knob, selector, etc.) 301. Examples of these instructions include methods for retrieving a dataset 303, processing the dataset 303 using an embedder model 304, and accessing cataloged embeddings 306. In some embodiments, a communications network 308 (e.g., similar to or different from external communications system 200 described above) may provide a conduit for the computing device 300 to receive the dataset 303. Generally, computing devices 300 may include smartphones, tablets, laptops, and desktop computers, as well as other locally or remotely connected devices (e.g., mobile device 172) which could be capable of interacting with a communications network 308. As an example, the computing device 300 may include a smart phone containing a processor 307 as well as the platform 10 as a downloaded application. Upon receiving input data 200 from, e.g., sensor 302, the input data 200 may be preprocessed or used as is. The smartphone may access the platform 10 as an application to run the instructions for receiving the input data 200 and processing the input data 200 to generate an embedding 202. In some computing devices, the platform may perform these steps automatically after the sensor is triggered or any time the input is used.

Embodiments of the disclosure may include training systems on the computing device 300 or that can be accessed through the communications network 308. The training computing system may include one or more processors 307 and a memory 309. The one or more processors 307 may be any suitable processing device (e.g., a processor core, a microprocessor, an ASIC, a FPGA, a controller, a microcontroller, etc.) and may be one processor or a plurality of processors that are operatively connected. The memory 309 may include one or more non-transitory computer-readable storage mediums, such as RAM, ROM, EEPROM, EPROM, flash memory devices, magnetic disks, etc., and combinations thereof. The platform 10 may include instructions 305 which are executed by the processor 307 to cause the training computing system to perform operations. In some implementations, the training computing system includes or is otherwise implemented by one or more server computing devices.

The model trainer may include computer logic utilized to provide desired functionality. The model trainer may be implemented in hardware, firmware, and/or software controlling a general purpose processor. For example, in some implementations, the model trainer includes program files stored on a storage device, loaded into a memory and executed by one or more processors. In other implementations, the model trainer includes one or more sets of computer-executable instructions that are stored in a tangible computer-readable storage medium such as RAM hard disk or optical or magnetic media.

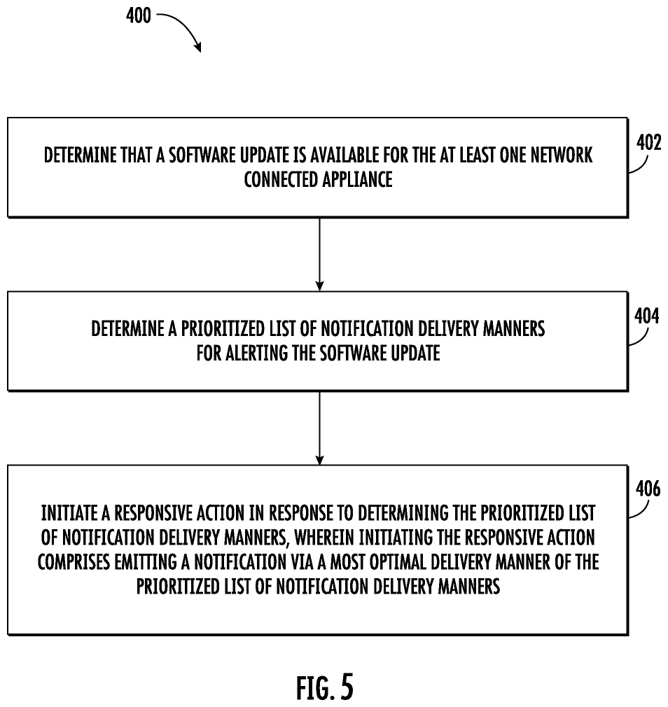

Referring now to FIG. 5, a computer implemented method 400 for generating and emitting notifications will be described. Method 400 may be performed, e.g., within computing device 300, on one of the system of network connected appliance 100, within external communication system 180 (e.g., at remote server 176 or external device 172). It should be noted that the steps presented in method 400 may be performed in any suitable order, and that more or fewer steps may be incorporated as needed.

At step 402, method 400 may include determining that an update is available for at least one network connected appliance of a system of network connected appliance (e.g., system 100). For instance, the remote server, the appliance itself, the computing device, or the like may determine that the update is available for the appliance. The update may include one or more software updates, coding updates, information regarding the appliance (e.g., such as error codes), warranty information, or the like. Accordingly, the update may be pushed by an external device, such as a cloud computer, or may be requested by the appliance (e.g., in the event of a failure, expiration, etc.). Additionally or alternatively, method 400 may monitor a time at which the update becomes available. For instance, the update may be made available or requested at varying times (e.g., throughout the day).

At step 404, method 400 may include determining a prioritized list of notification delivery manners for alerting the software update. As mentioned above, when an update is available for a network connected appliance, one or more alerts, notifications, messages, warnings, or notices may be created to be delivered or emitted to a user of the appliance. The notifications may be delivered in one or more of a plurality of manners, methods, means, modes, or the like. For some examples, the notifications may be sent directly to the appliance (e.g., displayed on a display or through a user interface of the appliance), as a text message to a registered mobile device of a user, as an email to a registered email address of a user, as a push notification to a mobile application (app) associated with the appliance, as an audio message through a network connected smart speaker, or the like. Thus, method 400 may formulate a priority list including each of the manners in which the notification may be delivered.

Determining the prioritized list of notification delivery manners may include labeling each of the plurality of delivery manners. For instance, upon prioritizing the list, the top delivery manner may be referred to as a most optimal delivery manner. Accordingly, a secondary delivery manner may be referred to as a second-most optimal delivery manner. As would be understood, subsequent delivery manners would be labeled in a like fashion.

According to some embodiments, method 400 may determine a usage pattern of the at least one network connected appliance. In detail, as mentioned above, one or more patterns may be monitored, recorded, stored, analyzed, or the like with respect to activity and interaction with the appliance. For one example, the appliance monitors, via one or more sensors, when a user interacts with the appliance. Such interactions may include inputs to the user interface, door openings (e.g., for a refrigerator, an oven, a laundry appliance, etc.), a heating element activation (e.g., for ovens, cooktops, etc.), cycle initiations (e.g., for laundry appliances), dispenser activations, or the like. Method 400 may then store (e.g., via embeddings as discussed above) the recorded usage data. From there, method 400 may develop a pattern of usage of the appliance or appliances. Such usage pattern may include schedules of usage (e.g., such as days of the week, times of the day, etc.). Additionally or alternatively, the usage pattern may include a peak usage time. For instance, method 400 may predict a peak usage of one or more network connected appliances based on prior historical data gleaned through the captured data.

In determining the usage pattern, method 400 may determine a pattern of notification acknowledgement via the network connected appliance. For instance, as mentioned above, the update notification may be sent directly to a user interface of the appliance, whereby the user may acknowledge or accept the notification. Method 400 may thus monitor the times or instances at which the notifications are acknowledged via the user interface of the appliance. The information relating to the acknowledgement times and instances may be coupled with the peak usage time of the appliance to determine an optimal time for delivering the notification to the appliance specifically. Accordingly, as would be expected, the prioritized list of notifications may be adjusted according to a specific time at which the notification is to be delivered or emitted.

According to some embodiments, in determining the usage pattern of the at least one network connected appliance, method 400 may receive feedback from a user with respect to delivered notifications. For instance, each notification sent to a user may include an option to provide feedback regarding the notification. The feedback may include information regarding the timing of the notification, the delivery means of the notification, the information and instructions included with the notification, or the like. The user feedback may be provided in a plurality of ways, such as through a mobile app, via text, via email, etc. The feedback may then be collected (e.g., within an external server). Accordingly, method 400 may analyze the received feedback data and incorporate the analysis into future notification deliveries.

Additionally or alternatively, the user feedback may be passive feedback. For instance, a user's interaction with the notification (or notifications) may be registered as feedback. Thus, method 400 may note and store a time at which each notification is acknowledged (e.g., a time of day, a day of week, etc.). Additionally or alternatively, the user feedback may include options selected. For instance, one or more notifications may include selectable options, such as install, download, ignore, delay, or the like. The prioritized list of notification delivery manners may thus include a plurality of factors, including timing of delivery, likelihood of response or acknowledgement, convenience of acceptance of the notification, limited annoyance of notification (e.g., through undesired noises, alarms, interruptions, etc.), and the like.

At step 406, method 400 may include initiating a responsive action in response to determining the prioritized list of notification delivery manners. The responsive action may include emitting the notification via the most optimal delivery manner of the prioritized list of notification delivery manners. As discussed above, the prioritized list of notification delivery manners may vary according to the time at which the notification is available. For example, if the notification is made available at an evening (e.g., between about 5:00 PM and about 7:00 PM), the most optimal delivery manner is different than if the notification is made available at a daytime (e.g., between about 10:00 AM and about 3:00 PM). Accordingly, the prioritized list of notification delivery manners may have different optimal delivery manners based on one or more factors, including time of day, day of week, etc.

Method 400 may, at step 406, include determining one or more attributes of each of the delivery manners. In detail, each delivery manner may be defined as either interactive or non-interactive. For example, delivery methods such as direct notification to the appliance user interface, a mobile app push notification, or a smart speaker audio notification may be considered as interactive manners. When the notification is delivered in an interactive manner, the user may immediately acknowledge the notification through a direct response (e.g., through the user interface of the appliance, via a voice command, etc.). Accordingly, such notifications may elicit immediate responses. In some instances, the interactive manners are preferred manners.

Similarly, delivery manners such as text messages, emails, or the like may be considered as non-interactive manners. For example, a text message including a notification of a software update may not include a direct way for the user to accept the update or acknowledge the update. As such, an extra step of accessing the appliance (e.g., via the mobile app or directly through the user interface) may be required for the responsive action to be initiated.

According to another example, the system of network connected appliances may include a first network connected appliance (e.g., a refrigerator) and a second network connected appliance (e.g., an oven range). It should be noted that additional or alternative network connected appliances may be included or substituted, and the embodiment described herein is provided by way of example only. In this example, the prioritized list of notification delivery manners may include interactive manners as the most optimal and the second-most optimal delivery manners. For instance, the most optimal delivery manner may be a direct notification to the user interface of the first appliance, while the second-most optimal delivery manner may be a direct notification to the second appliance. The notification may include a software update for the first appliance only. Although the update is for the first appliance, the notification may be delivered to each network connected appliance. Advantageously, the user may notice and acknowledge the notification even if distant from the first appliance.

Upon determining that the most optimal delivery manner of the prioritized list of notification delivery manners is an interactive manner, method 400 may proceed to emit the notification in each of the most optimal delivery manner and the second-most optimal delivery manner. Accordingly, referring again to the example above, the notification may be delivered to each of the first appliance (e.g., user interface) and the second appliance (e.g., user interface). Since each of the notifications is an interactive notification, method 400 may monitor whether the user acknowledges (e.g., accepts) the notification.

Method 400 may then determine that the first notification (e.g., on the first appliance) has been acknowledged. Upon determining that the first notification has been acknowledged, method 400 may then clear the second notification from the second appliance. For instance, the second notification may appear as a graphic on the user interface of the second appliance. Thus, when the first notification is acknowledged, method 400 may clear or delete the second notification from the second appliance. Advantageously, the user is not required to clear each interactive notification from each connected appliance, increasing satisfaction.

According to some embodiments, method 400 may include determining that the notification has not been acknowledged within a predetermined time limit after emitting the notification via the most optimal delivery manner. For instance, the predetermined time limit may be prestored within the appliance, may be set by a user, or may vary according to the time of notification delivery, the delivery manner, or historical data regarding acceptance or acknowledgement times.

Upon determining that the notification has not been acknowledged within the predetermined time limit, method 400 may emit the notification via one or more lower priority delivery manners of the prioritized list of notification delivery manners. For instance, method 400 may instruct the notification to be sent by each notification delivery manner available. Accordingly, the notification may be sent by each interactive manner and each non-interactive manner.

As described herein, notifications may be provided to users according to established routines of the user. For instance, a particular location of the user at a particular time may factor into the highest or most optimal delivery manner. Further, it should be understood that the method described herein may apply to additional or alternative notifications, such as notifications regarding operations on different appliances (e.g., a notification of a complete cycle within a laundry appliance). Thus, the notification may be any suitable notification including a breadth of information, commands, requests, triggers, or the like.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a system of domestic appliances, the system comprising at least one network connected appliance, the method comprising:
determining that a software update is available for the at least one network connected appliance;
determining a prioritized list of notification delivery manners for alerting the software update; and
initiating a responsive action in response to determining the prioritized list of notification delivery manners, wherein initiating the responsive action comprises emitting a notification via a most optimal delivery manner of the prioritized list of notification delivery manners.

2. The method of claim 1, wherein the prioritized list of delivery manners comprises at least two of an appliance display, a text message, a phone application (app) push notification, an email, or an audio alert.

3. The method of claim 1, wherein initiating the responsive action further comprises:
determining that the most optimal delivery manner of the prioritized list of notification delivery manners is an interactive manner; and
emitting the notification via a second-most optimal delivery manner of the prioritized list of notification delivery manners in addition to the most optimal delivery manner.

4. The method of claim 1, further comprising:
determining that the notification has not been acknowledged within a predetermined time limit after emitting the notification via the most optimal delivery manner; and
emitting the notification via one or more lower priority delivery manners after determining that the notification has not been acknowledged.

5. The method of claim 1, wherein determining the prioritized list of notification delivery manners further comprises:
determining a usage pattern of the at least one network connected appliance after determining that the software update is available, the usage pattern comprising a peak usage time for the at least one network connected appliance.

6. The method of claim 5, wherein determining the usage pattern of the at least one network connected appliance comprises:
determining a pattern of notification acknowledgement via the at least one network connected appliance.

7. The method of claim 5, wherein determining the usage pattern of the at least one network connected appliance comprises:
receiving user feedback with respect to delivered notifications.

8. The method of claim 7, wherein receiving the user feedback with respect to the delivered notifications comprises:
determining a time of day at which the delivered notification is acknowledged.

9. The method of claim 1, wherein the at least one network connected appliance comprises:
a first network connected appliance; and
a second network connected appliance.

10. The method of claim 9, further comprising:
receiving an input signal to accept the notification on the first network connected appliance; and
clearing the notification from the second network connected appliance after receiving the input signal on the first network connected appliance.

11. A computing system for emitting software update notifications, the computing system comprising:
at least one network connected appliance;
one or more processors in communication with the at least one network connected appliance; and
one or more non-transitory computer-readable media that collectively store instructions that, when executed by the one or more processors, cause the computing system to perform operations, the operations comprising:
determining that a software update is available for the at least one network connected appliance;
determining a prioritized list of notification delivery manners for alerting the software update; and
initiating a responsive action in response to determining the prioritized list of notification delivery manners, wherein initiating the responsive action comprises emitting a notification via a most optimal delivery manner of the prioritized list of notification delivery manners.

12. The computing system of claim 11, wherein the prioritized list of delivery manners comprises at least two of an appliance display, a text message, a phone application (app) push notification, an email, or an audio alert.

13. The computing system of claim 11, wherein initiating the responsive action further comprises:
determining that the most optimal delivery manner of the prioritized list of notification delivery manners is an interactive manner; and
emitting the notification via a second-most optimal delivery manner of the prioritized list of notification delivery manners in addition to the most optimal delivery manner.

14. The computing system of claim 11, wherein the operations further comprise:
determining that the notification has not been acknowledged within a predetermined time limit after emitting the notification via the most optimal delivery manner; and
emitting the notification via one or more lower priority delivery manners after determining that the notification has not been acknowledged.

15. The computing system of claim 11, wherein determining the prioritized list of notification delivery manners further comprises:
determining a usage pattern of the at least one network connected appliance after determining that the software update is available, the usage pattern comprising a peak usage time for the at least one network connected appliance.

16. The computing system of claim 15, wherein determining the usage pattern of the at least one network connected appliance comprises:
determining a pattern of notification acknowledgement via the at least one network connected appliance.

17. The computing system of claim 15, wherein determining the usage pattern of the at least one network connected appliance comprises:
receiving user feedback with respect to delivered notifications.

18. The computing system of claim 17, wherein receiving the user feedback with respect to the delivered notifications comprises:
determining a time of day at which the delivered notification is acknowledged.

19. The computing system of claim 11, wherein the at least one network connected appliance comprises:
a first network connected appliance; and
a second network connected appliance.

20. The computing system of claim 19, wherein the operations further comprise:
receiving an input signal to accept the notification on the first network connected appliance; and
clearing the notification from the second network connected appliance after receiving the input signal on the first network connected appliance.
